(19) United States
(12) Patent Application Publication
(10) Pub. No.: US 2014/0210965 A1
(43) Pub. Date: Jul. 31, 2014

(54) Method for Securing Visual Media Utilizing Encoding Process With Optical Translation for Decoded Image Viewing

(71) Applicants: Jason David Goodman, Los Angeles, CA (US); James Vincent Masi, New York, NY (US)

(72) Inventors: Jason David Goodman, Los Angeles, CA (US); James Vincent Masi, New York, NY (US)

(21) Appl. No.: 14/168,135

(22) Filed: Jan. 30, 2014

Related U.S. Application Data
(60) Provisional application No. 61/759,252, filed on Jan. 31, 2013.

(51) Int. Cl. H04N 13/04

(52) U.S. Cl. CPC H04N 13/0459; H04N 13/0429; H04N 13/0438
USPC 348/56; 348/51; 348/54

(57) ABSTRACT

A method and system for securing visual media utilizing an encoding process with optical translation for decoded image viewing having the steps of displaying a first image for viewing by a user, generating a second image that is substantially a negative of the first image, displaying the first and second image through a stereoscopic projection system using at least two separate channels of the system to create a displayed garbled image decoding the displayed image by cancellation of the second image from the view of said user. The system may also employ active and passive 3D glasses or other decoder and generate interference and other signals to obscure the desired image before decoding. The system may also be used with handheld display devices such as tablets, notebooks and smart phones utilizing decoding screens or user wearable devices.

### CROSS REFERENCE TO RELATED APPLICATIONS

This application takes priority from provisional application for patent Ser. No. 01/759,252 filed Jan. 31, 2013 entitled “Method for Securing Visual Media Utilizing Encoding Process Requiring Optical Translation for Decoded Image Viewing” and is incorporated as if fully set forth herein.

### FIELD OF THE INVENTION

The present invention relates to securing moving pictures, film exhibitions and other images, and more particularly to a Method for Securing Visual Media Utilizing Encoding Process With Optical Translation for Decoded Image Viewing.

### DESCRIPTION OF ATTACHED APPENDIX

Not Applicable

### BACKGROUND OF THE INVENTION

Illicit copying, or “piracy,” of visual media problematic and costly. The Motion Picture Association of America (“MPAA”), serves as the primary representative and advocate of the American motion picture, home video and television industries, throughout the world. According to the MPAA, film and television production is not isolated to Hollywood or New York, but, rather, is part of a nationwide economic engine supporting 2.1 million jobs and approximately $143 billion in 2010 wages. Indeed, according to the MPAA, the production and distribution of motion pictures and television programs is one of America's most valuable economic and cultural resources.

Balanced against this lucrative industry, a pillar of the American economy, is the evolution of film piracy and intellectual property infringements. Counterfeiting has evolved from a relatively small industry concentrating on high-end designer goods to a complex network involved in the mass production of products from pharmaceuticals to electronics,. Exponential growth in the piracy of copyrighted products in all formats is bolstered by the minimal investment required to produce counterfeit materials and the relatively minor penalties imposed should the infringer be caught. According to the MPAA, pirated motion pictures alone impact the American economy with losses measured in billions of Dollars. Estimates state that 90% of that loss occurs within the first six to eight weeks of a film's release and is primarily due to the unauthorized camcording of movies during screenings, together with the concomitant duplication and subsequent illicit sales. The advent of wearable glass computing devices capable of taking video has further exacerbated the problem.

During a recent industry discussion, movie studio executives detailed the tremendous economic impact that piracy and counterfeiting has had on the movie and television production businesses. Illegal camcording and other unauthorized filming is now a felony in the United States.

Unwanted, illegal or impermissible copying of visual media is not limited to the motion picture industry. This invention will protect any visual media, from the unwanted viewing of a computer screen to the passwords entered by consumers at automatic teller machines.

Previous inventions either fail to prevent illicit duplication and merely identify the source of duplication, or are very easily defeated through digital manipulation or optical filters placed over lenses. Other patents have failed to prevent the unauthorized copying of visual media. For example, spatial light modulators employing digital micromirror devices or liquid crystal device technologies have failed. U.S. Pat. Nos. 4,441,791; 5,535,047; 5,600.383 (all to Hornbeck); and U.S. Pat. No. 5,719,695 (Heimbuch). Optical designs for projection apparatuses employing DMDs are disclosed in U.S. Pat. No. 5,914,818 (Tejada et at); U.S. Pat. No. 5,930,050 (Dewald); U.S. Pat. No. 6,008,951 (Anderson); and U.S. Pat. No. 6,089,717 (Iwai); U.S. Pat. No. 5,808,795 (Shimomura et at); U.S. Pat. No. 5,798,819 (Hattori et at); U.S. Pat. No. 5,918,961 (Ueda); and U.S. Pat. No. 6,062,694 (Oikawa et al.); U.S. Pat. No. 1,463,310 (Nelson). These spatial light modulators are easily defeated with digital technologies. Alternatively, the degradation in visual quality is insufficient to deter end-users who are motivated by the nominal relative expense.

Further, patents seeking to apply a watermark as a means to prevent piracy are misapplied. An invisible watermark identifies the visual media copied but does not prevent a person from viewing it or copying it. U.S. Pat. No. 5,875,249 (Mintzer et at); U.S. Pat. No. 6,031,914 (Tewfik et al.); U.S. Pat. No. 5,912,972 (Barton); and U.S. Pat. No. 5,949,885 (Leighton); U.S. Pat. No. 5,960,081 (Vynne et al.); U.S. Pat. No. 5,809,139 (Girod et at); U.S. Pat. No. 6,069,914 (Cox); and U.S. Pat. No. 6,037,984 (Isnardi et al.).

Previous methods require additional equipment to protect the visual media, fail to encode it even for the intended viewer or fail to degrade the quality of the illegally copied visual media sufficiently to prevent distribution. Our invention relies on existing digital motion picture transmission and exhibition hardware and provides superior protection of the visual media through the encoding and decoding process utilizing security eyeglasses.

Our invention relies on existing digital motion picture transmission, picture presentation methods and exhibition hardware. It provides superior protection of the visual media through the encoding and decoding process utilizing security eyeglasses.

### BRIEF SUMMARY OF THE INVENTION

In accordance with a preferred embodiment of the invention, there is shown a a method for securing visual media utilizing encoding process having the steps of projecting a first image for viewing by a user through a stereoscopic projection system, simultaneously projecting a second image that is substantially a negative of the first image through the stereoscopic projection system, displaying the first and second image through the stereoscopic projection system using at least two separate channels of the aid system to create a displayed image on a viewing screen and decoding the displayed image by cancellation of the second image from the view of the user.

In accordance with another preferred embodiment of the invention, there is shown a method for securing visual media utilizing an encoding process having the steps of displaying a first video image for viewing by a user, simultaneously generating a second video image that substantially interferes visually with the first image when viewed together, displaying the first and second video images through a 3D stereoscopic projection system to create a displayed image of the first and second video images, and decoding the displayed image by cancellation of the second video image to the user with a canceller to reveal the first video image.

In accordance with a preferred embodiment of the invention, there is shown a a system and method for securing visual media utilizing a 2D digital image and a digitized obscuring image of the 2D digital image, a display for a user that shows simultaneously the 2D image and the obscuring image, and further comprising the step of decoding the displayed image by cancellation of he obscuring image to the view of said user with canceller to reveal the 2D digital image.

### BRIEF DESCRIPTION OF THE DRAWINGS:

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 shows a schematic diagram of a stereoscopic projection of images generated by the preferred embodiment of the present invention.

FIG. 2 shows a block diagram of the method steps of a preferred embodiment of the invention.

FIG. 3A shows projection with prior art 3D glass system to create a 3D image.

FIG. 3B shows projection and decoding with 3D glasses according to a preferred embodiment of the present invention.

### DETAILED DESCRIPTION OF THE PREFERRED EMBODIMENTS:

Detailed descriptions of the preferred embodiments are provided herein, it to be understood, however, that the present invention may be embodied in various forms. Various aspects of the invention may be inverted, or changed in reference to specific part shape and detail, part location, or part composition. Therefore, specific details disclosed herein are not to be interpreted as limiting, but rather as a basis for the claims and as a representative basis for teaching one skilled in the art to employ the present invention in virtually any appropriately detailed system, structure or manner

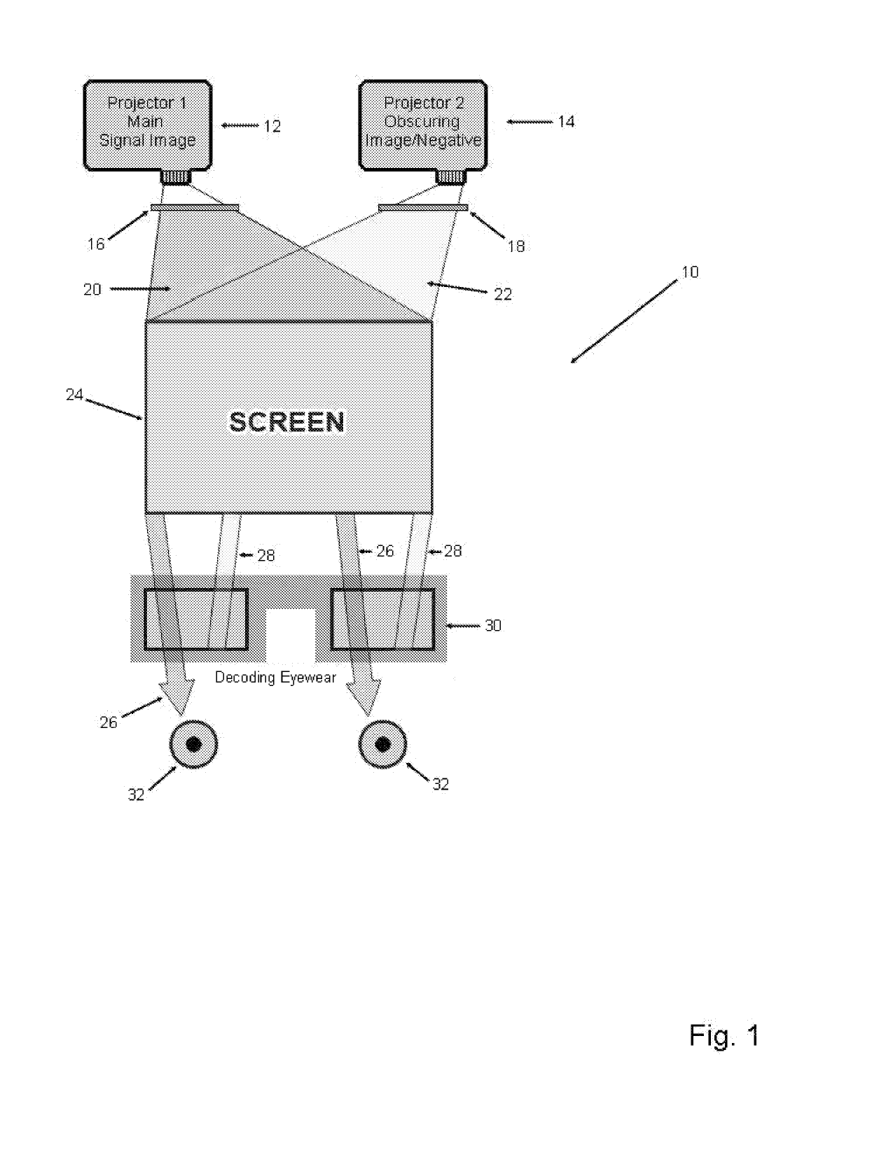

Turning now to FIG. 1, there is shown a three dimensional or 3D projection system using dual projections that has a right and left signal. In conventional practice, the two signals are created initially from different vantage points to create a left and right eye projection. When displayed through the projectors, the resultant image seen by the user has a 3D effect since each eye is seeing a slightly different perspective of the original image.

In the present invention, as shown in FIG. 1, and for example purposes, projections system 10 has projector 1 that projects main signal image 12 and projector 2 that projects obscuring image/negative 14 that are simultaneously projected through an electro optical switch, polarizer, or other type of optical filters 16 and 18 producing projection image streams 20 and 22 onto screen 24. These images may also be digitally generated using one projection system that creates a left and right eye signal. A user wears decoding eyewear 30 that blocks the right eye reflected stream 28 and permits the left eye reflected stream 26 to user eyes 32. Obscuring image/negative 14 is generated as a blocking, interference or negative signal that results in screen 24 showing a garbled and unintelligible image. When displayed, the two images or video sequences cancel each other out or create an obscured or other unviewable image. Thus. when being presented at a movie theater or from any other visual display device, the resultant image is unviewable. It is only viewable when using the glasses, or other optical filter, of the present invention.

As shown in FIG. 1, decoding eyewear 30 is shown with two left eye image lenses, In this fashion, when the two signals are simultaneously displayed on screen 24 only main signal image 12, which preferably is a 2D image, is seen, as the left eye lenses do not allow the right eve signal to pass through to the user's eyes. The user thus sees main signal image 12 on screen 24 without interference from obscuring imager negative signal 14. This may be accomplished with any of a variety of viewing mechanisms, including 3D glasses, a polarizing screen or other system that permits one signal intended for the left eye, and the other signal intended for the right eye.

Another embodiment may rely on a parallax barrier viewing system that presents the two eye perspectives from a viewing screen such as a computer, notebook, tablet, smart phone or other device. As the screen is designed to create a 3D effect by using two unique eye view perspectives, a similar system using a blocking signal for one eye and a decoder or canceller for the interference or obscuring signal may be employed to permit viewing of the desired 2D signal.

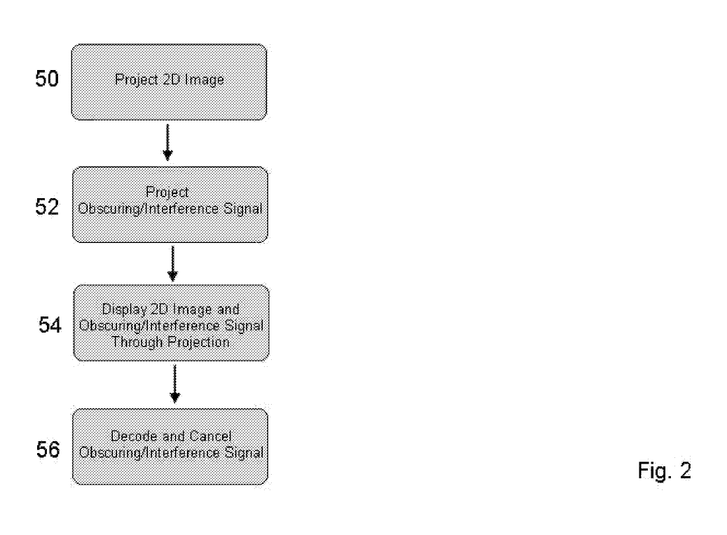

FIG. 2 shows a basic flow diagram of the present invention. A preferred embodiment of the invention includes: 1) encoding into a proprietary secure digital format two signals one a main signal that is desired and a second signal that obscures or interferes with the main signal; 2) delivery and exhibition through existing conventional stereoscopic digital cinema hardware and software or other existing display technologies; and 3) decoding through proprietary eyewear.

In operation, the preferred embodiment achieves the following: 1) secure the visual media; 2) delivers the secure media to existing digital cinema projectors or displays for exhibition; and 3) allows legitimate use of the visual media while preventing illicit duplication or viewing. Once the material is encoded in the secure format, it can be projected in an ordinary digital cinema equipped with stereoscopic playback and projection hardware or any other means of displaying visual media. When viewed or recorded by camera without the security glasses an indiscernible image is presented. When viewed through the proprietary security eye wear, a normal high quality motion picture image is seen.

As shown in FIG. 2, step 50 is the projection of a 2D image or video constituting the main signal or desired information. At step 52, the method projects a previously or real time generated interference, obscuring or negative signal to the main signal that is projected at the same time as the rain signal. At step 54, the two signals are simultaneously displayed through a 3D projection system onto a screen or alternatively may be generated through a tablet, notebook or other display. At step 56, the resultant image that is displayed is viewed through glasses or other decoder device that removes the right eye image generated by the stereoscopic display device. Thus, the viewer is presented with a viewable image of the main signal only upon using the decoder or glasses that block the right eye signal that was obscuring proper viewing of the main signal or image.

In the present invention, there is shown a method and system to secure visual media through the use of storage, playback and display technologies, formerly associated only with stereoscopic imagery, which are advanced to provide for the encoding, transmission and presentation of visual media and/or moving pictures in a manner that prevents viewing without the use of specialized decoding security eyeglasses. Watching, recording or copying secured visual media is rendered impossible without the described viewing apparatus, preventing, amongst other things, piracy or other forms of infringement on intellectual property protections.

Another embodiment includes a reflective coating on the front of the security eyeglasses making them visible in the dark to all but the person wearing them. An alternative embodiment includes electronic security eyeglasses that will only function when a completed circuit is formed via signal conductivity over human skin as worn on the viewer's face.

Making the invention uses in part known systems for stereoscopic encoding, transmission and projection technologies. The secure format has nothing to do, however, with stereoscopic technology and in fact is only suitable for monoscopic (normal 2D) motion pictures or other non 3D visual media according to the present invention.

The method of a preferred embodiment is comprised of inserting one image into the channel of a stereoscopic system for the monoscopic program image, and the alternate image channel for a cancellation image, thereby encoding the visual media and preventing the viewing, capture or reproduction of the encoded, secured visual media without the corresponding security eyeglasses which decode only the program image and eliminate the cancellation image. Generating a negative or other interference signal is well known in the art and can be accomplished in any of number of ways with a variety of coir commercially available software tools The first is to generate a “negative” from the positive 2D image or video which in most respects will cancel the main image when simultaneously displayed.

As such, the visual media is secured and is only able to be seen by a human being wearing the corresponding decoder glasses or using a decoding screen during an original screening or viewing and not after an illicit copy is made. The coded image is not susceptible to being recorded in any viewable format.

In an alternative embodiment, the cancellation image may be generated by any of a variety of well known means to create a second signal that upon being displayed simultaneously with the subject signal creates an unviewable image. For example, the second image may be programmatically generated by an algorithm or other pre-determined or random sequence to create a second signal sufficient to obscure the main image. There may be secondary signals that are not complete negatives of the original signal that may effectively defeat viewing. The signal just needs to be sufficient to obscure the ultimate viewing of the main image when overlayed on the main signal.

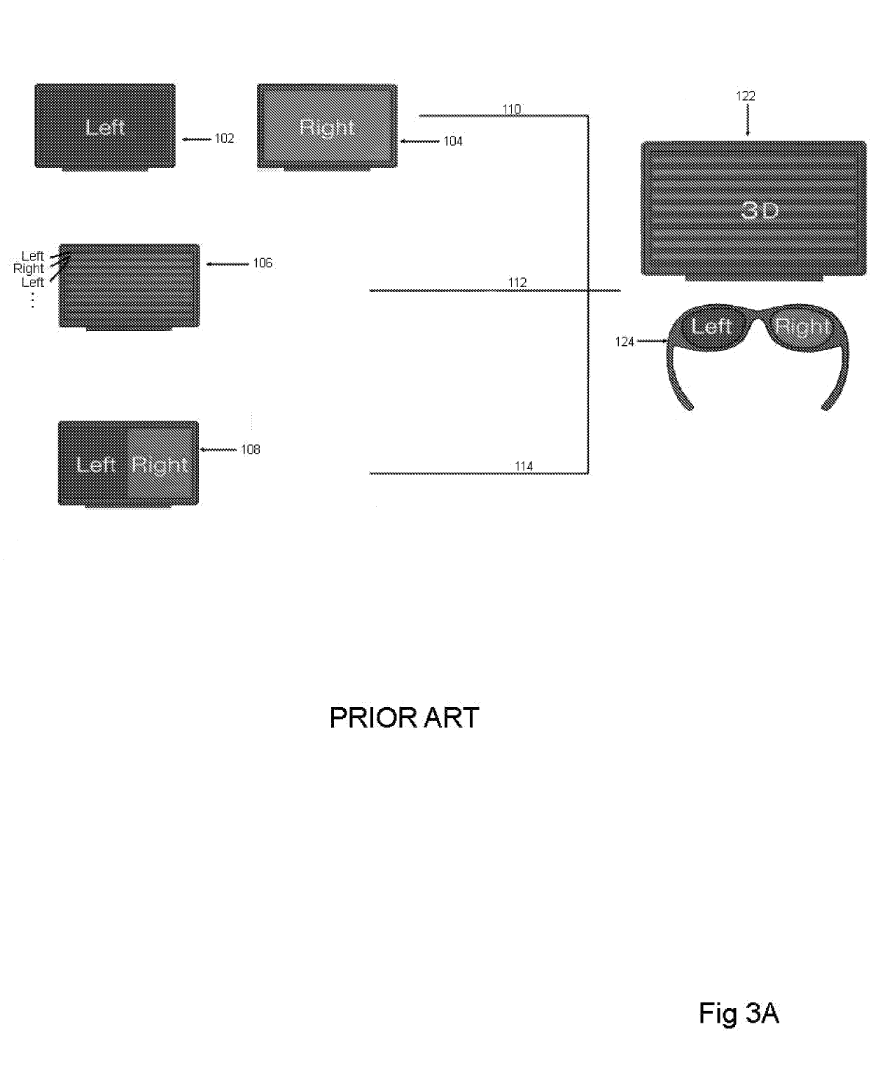

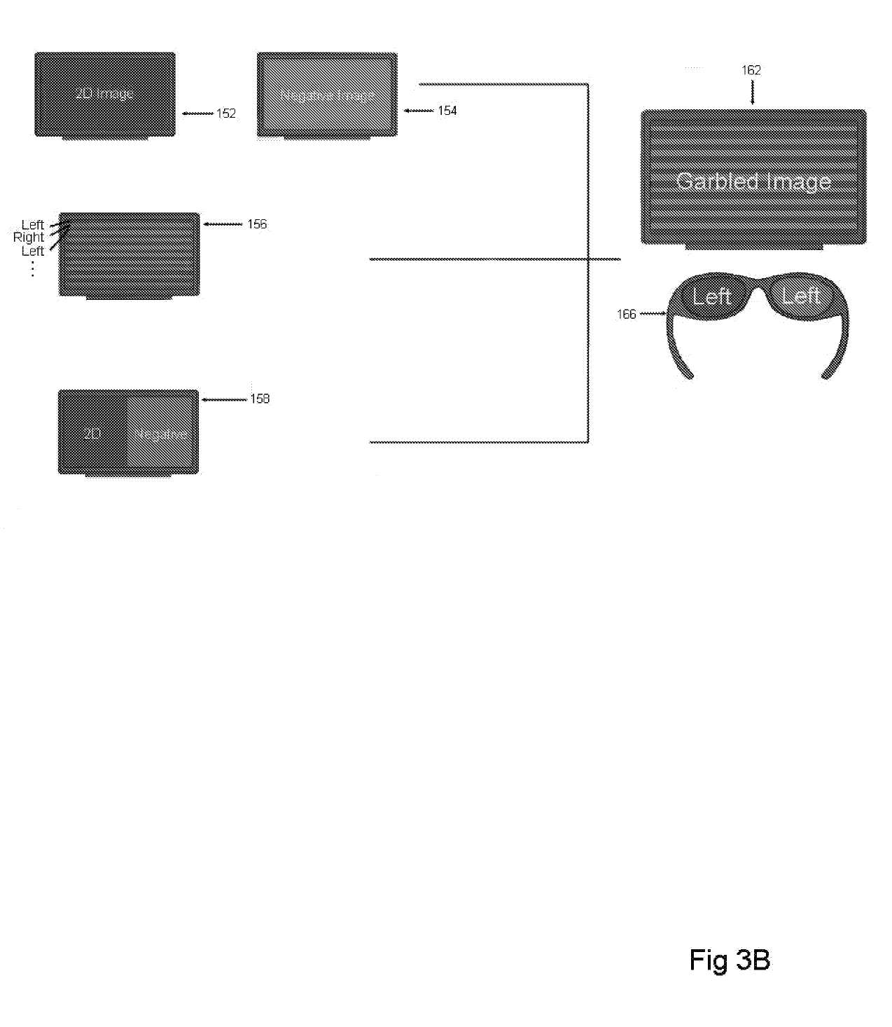

As shown in FIG. 3A, three different encoding modes are shown that constitute prior art systems. Conventionally in a 3D environment, viewing may be accomplished with a shuttering active 3D glass or a passive polarized glass. An active shutter 3D system or alternate frame sequencing, alternate image, AI, alternating field, field sequential or eclipse method is a technique of displaying stereoscopic 3D image It works by only presenting the image intended for the left eye while blocking the right eye's view, then presenting the right-eye image while blocking the left eye, and repeating this so rapidly that the interruptions do not interfere with the perceived fusion of the two images into a single 3D image. Active shutter 3D systems generally use quid crystal shutter glasses (also called “LCS glasses”, “LCS 3D glasses”, “LC shutter glasses” or “active shutter glasses”. Each eye's glass contains a liquid crystal layer which has the property of becoming opaque when voltage is applied, being otherwise transparent. The glasses are controlled by a timing signal that allows the glasses to alternately block one eye, and then the other, in synchronization with the refresh rate of the screen. The timing synchronization to the video equipment may be achieved via a wired signal, or wirelessly by either an infrared or radio frequency (e.g. Bluetooth, DLP link) transmitter.

Active shutter 3D systems are used to present 3D films in some theaters, and they can be used to present 3D images on CRT, plasma, LCD and other types of video displays. Active 3D technology is generally based on a display with a single image channel (such as a conventional 2D television, or digital projector) and glasses with lenses of a variable state ranging from virtually transparent to virtually opaque. Most often, liquid crystal lenses are utilized. Left and right images are presented in rapid alternating succession on the screen. The display sends a ireless or wired signal to the glasses indicating when each of the left and right eye images are being displayed on screen at a given instant. When the left eye image is on screen, the right eye lens is opaque. When the right eye image is on screen, the left eye lens is opaque. The alternating sequence happens at a very high rate of speed simulating simultaneous presentation. The present invention takes the concept but applies it to secure 2D viewing in lieu of 3D capability. The glasses are modified such that both left and right eye lenses are virtually transparent when left eye images are displayed on screen, and similarly, both lenses are opaque when the right eye image is displayed on screen. The net effect is that both of the viewer's eyes see the program image, which is the content of the movie, and both eyes see nothing due to opaque lenses when the interference image is displayed on screen. The alternating of images happens so rapidly it appears to simulate seamless motion to the viewer.

Passive 3D technology refers to any stereoscopic system in which the glasses do not contain electronic components, but rather use optical filtration lenses to achieve image separation. This can be done with two independent projectors, each fitted with a polarizing filter, one clockwise, the other counter clockwise. This can also be done similarly to active 3D. Projecting left and right images in rapid succession, however with passive 3D projection the polarization switch is placed on the projector rather than on the viewers eyes. The active element on the projector polarizes light in either clockwise or counterclockwise orientation and corresponding optical polarizing lenses are used in the glasses. In the case of passive polarized 3D television, alternating rows of polarizing film are embedded in the LCD or PDP pixels. Even rows of pixels are encoded for one of the polarizing lenses, odd rows are encoded for the opposite polarizing lens.

Adding the reflective outer surface to the eyewear enhances the invention by allowing a human security officer to detect removal of the glasses from a viewer's face as might occur in the event of impermissible recording. Optionally utilizing electronic security glasses further enhances security of the system by requiring the glasses to be worn on a viewer's face in order to operate.

Turning back to FIG. 3A showing three different prior art systems, left image 102 and right image 104 are generated from a conventional 3D camera system, and are processed using signals through for example two HD SDI lines via line 110. In another version, left image 102 and right image 104 are transmitted line by One using HD SDI or DVI-D in each One as shown by combined image 106 through line 112. Another version may have left signal 102 and right signal 104 transmitted side by side as shown in image 108 again with HD SDI or DVI-D in each transmission line through line 114. Displayed image 122 shows alternative left and right lines that reflect the original left and right signals. These signals are decoded using glasses 124 that have left and right polarization so that each eye only sees its respective signal, thus creating a 3D appearance.

In the present invention, as shown in FIG. 3B, the same system as shown in FIG. 3A is employed but in this case the desired image or 2D image for ultimate viewing is 2D image 152 and the right signal is negative image signal 154. The signals may be transmitted as previously described in FIG. 3A and done in a variety of ways, with a preferred embodiment being a generated negative of the original 2D image or video to the right eye. This negative is then presented on screen and causes the resultant image or video to be unviewable or garbled image 162. By using glasses 166 the left and right eye views are the same, and only permit the left image to be seen. In this way, the blocking image that would ordinarily prevent viewing of the film, image or other video signal, is removed and the user sees the 2D signal as if he were at a conventional theater or using a conventional viewing screen. Although for example, we describe the main signal as the left eye signal, it alternatively may presented to the right eye with the obscuring image presented to the left and still use the benefits of the present invention. Alternatively, other decoding devices may be employed that block the visual perception of the interference or blocking image.

The present invention is based on projecting a normal program image and a specially calibrated interference image onto a single screen. The interference image is designed to cancel out the program image. When viewed with special glasses or other decoding device, only the program image is seen: When viewed without the glasses, the program image plus interference image creates the canceled image. The interference image is preferably made as a negative image of each frame of the program image. In a preferred embodiment, to further decimate the canceled image, this negative is combined with a moving text track that is animated across the entire frame throughout the duration of the motion picture. The text track can be filled with a gradient or any kind of color cloud but it must be applied in the “lighten only” mode. The motion of the text is visible only in the interference image and the canceled image. The program image and interference image are then encoded into an industry standard 3D DCP with normal SMPTE specifications.

General practice involves a file structure that is organized into a number of usually multi-gigabyte size Material eXchange Format (MXF) files, which are separately used to store audio and video streams, and auxiliary index files in XML format. The MXF files contain streams that are compressed, encoded, and encrypted, in order to reduce the huge amount of required storage and to protect from unauthorized use. The image part may be JPEG 2000 compressed, whereas the audio part may be linear PCM, The adopted (optional) encryption standard is typically AES 128 bit in CBC mode.

This DCP can then be played on any DCI server and 3D DCI projector. When the theater is equipped with a 3D compatible digital projector and Secure Exhibition glasses and transmitter, the viewer sees only the intended program image. In order for the preferred embodiment to work effectively, users could not easily eliminate or shuffle the key components of the projection and decoding process. The encoded visual media would be played back on a normal stereoscopic digital cinema projector or other display device, with the intended viewer(s) wearing the required security glasses.

Additionally, any visual media can be secured from viewers who do not have access to the proprietary eyewear perhaps sensitive information such as the monitor for an x-ray scanner at an airport or other visual media which is sought to be secured from viewing or copying by anyone other than permissible viewers

In an alternative embodiment, the two signals may be decoded by a programmatic decoding glass that wirelessly recognizes the obscuring image and blocks it from being viewed by the user. This may rely on wireless technology well know in the art and the sending of a signal to the glasses to synchronize shuttering or other action to prevent one eye from seeing the obscuring image and revealing only the main image.

While the invention has been described in connection with a preferred embodiment it is not intended to limit the scope of the invention to the particular form set forth, but on the contrary, it is intended to cover such alternatives, modifications, and equivalents as may be included within the spirit and scope of the invention as defined by the appended claims.

We claim:

1. A Method for Securing Visual Media Utilizing Encoding Process comprising the steps of:
a. projecting a first image for viewing by a user through a stereoscopic projection system;
b. simultaneously projecting a second image that is substantially a negative of said first image through said stereoscopic projection system;
c. displaying said first and second image through said, stereoscopic projection system using at least two separate channels of said system to create a displayed image on a viewing screen; and
d. decoding said displayed image by cancellation of said second image from the view of said user.

2. The Method for Securing Visual Media. Utilizing Encoding Process as claimed in claim 1 further comprising the step of presenting said two images line by line.

3. The Method for Securing Visual Media Utilizing Encoding Process as claimed in claim 1 further comprising the step of adding text to the second image.

4. The Method for Securing Visual Media Utilizing Encoding Process as claimed in claim 1 further comprising the step of using 3D glasses to decode said displayed image.

5. The Method for Securing Visual Media Utilizing Encoding Process as claimed in claim 1 further comprising 3D glasses having the same polarization in each eye.

6. The Method for Securing Visual Media. Utilizing Encoding Process as claimed in claim 4 further comprising active shutter 3D glasses.

7. A Method for Securing Visual Media Utilizing Encoding Process comprising the steps of:
a. displaying a first video image for viewing by a user;
b. simultaneously generating a second video image that substantially interferes visually with said first image when viewed together;
c. displaying said first and second video images through a 3D stereoscopic projection system to create a displayed image of said first and second video images; and
d. decoding said displayed image by cancellation of said second video image to said user with a canceller to reveal said first video image.

8. The Method for Securing Visual Media Utilizing Encoding Process as claimed in claim 7 where said canceller are glasses worn by said user said glasses having an intermittent frame shutter for each eye.

9. The Method for Securing Visual Media Utilizing Encoding Process as Maimed in claim 7 further comprising the step of making said second video image a substantial negative of said first video image.

10. The Method for Securing Visual Media Utilizing Encoding Process as claimed in claim 7 further comprising the step of making said second video image visually obscure said first image.

11. The Method for Securing Visual Media Utilizing Encoding Process as claimed in claim 7 further comprising the step of using 3D glasses that show the first video image in both eyes.

12. The Method for Securing Visual Media Utilizing Encoding Process as claimed in claim 7 further comprising active 3D glasses.

13. The Method for Securing Visual Media Utilizing Encoding Process as claimed in claim 7 further comprising the step of generating said second image through pre determined program.

14. A System and Method for Securing Visual Media comprising:
a. a 2D digital image and a digitized obscuring image of said 2D digital image;
b. a display for a user that shows simultaneously said 2D image and said obscuring image; and
c. further comprising the step of decoding said displayed image by cancellation of said obscuring image to the view of said user with canceller to reveal said 2D digital image.

15. The System and Method for Securing Visual Media Utilizing Encoding Process as claimed in claim 14 further comprising active 3D glasses.

16. The System and Method for Securing Visual Media Utilizing Encoding Process as claimed in claim 14 further comprising passive 3D glasses.

17. The System and Method for Securing Visual Media Utilizing Encoding Process as claimed in claim 14 further comprising a decoder screen.

18. The System and Method for Securing Visual Media Utilizing Encoding Process as claimed in claim 14 further comprising the step of generating an obscuring image through random generation.

19. The System and Method for Securing Visual Media Utilizing Encoding Process as claimed in claim 14 further comprising the step of programmatically decoding said displayed image with wireless glasses.

20. The System and Method for Securing Visual Media Utilizing Encoding Process as claimed in claim 14 further comprising inserting text into said obscuring image.
